(19) United States
(12) Patent Application Publication
(10) Pub. No.: US 2024/0424520 A1
(43) Pub. Date: Dec. 26, 2024

(54) ROBOTIC GAP FILLER APPLICATION STATION

(71) Applicant: FCA US LLC, Auburn Hills, MI (US)

(72) Inventors: Dawei Li, Shanghai (CN); Xujin Ling, Shanghai (CN); Zhaoping Wang, Shanghai (CN)

(21) Appl. No.: 18/337,997

(22) Filed: Jun. 20, 2023

(51) Int. Cl. B05C 5/02

(52) U.S. Cl. CPC B05C 5/0216; B05C 5/0225

(57) ABSTRACT

A robotic gap filler application station for an assembly line includes a robotic arm, a tooling head coupled to an end of the robotic arm, a first dispensing nozzle removably coupled to the tooling head and configured to dispense a first type of gap filler material, and a second dispensing nozzle removably coupled to the tooling head and configured to dispense a second type of gap filler material. A gap filler dispensing system is configured to supply the first and second types of gap filler material to the respective first and second dispensing nozzles to simultaneously apply the first and second types of gap filler to a component on the assembly line.

### FIELD

The present application relates generally to robotic assembly line systems and, more particularly, to a robotic gap filler application station.

### BACKGROUND

Conventional robotic assembly systems are commonly used in assembly lines to perform repeated operations to assemble a final product. Such automated assembly may be preferable to manual human assembly due to increased speed and precision leading to decreased costs. These conventional robotic assembly systems typically include one or more stations having a robotic arm with multiple segments that enable various degree of freedom movements, which may be controlled by a computer, hydraulics, pneumatics, etc. However, the robotic arms are often limited to a single operation with a fixed production capacity. One way to improve production capacity is to add additional stations. However, this can greatly increase the cost of the entire production line. Accordingly, while conventional robotic systems work well for their intended purpose, there is a desire for improvement in the relevant art.

### SUMMARY

In accordance with one example aspect of the invention, a robotic gap filler application station for an assembly line is provided. In one example implementation, the robotic gap filler application station includes a robotic arm, a tooling head coupled to an end of the robotic arm, a first dispensing nozzle removably coupled to the tooling head and configured to dispense a first type of gap filler material, and a second dispensing nozzle removably coupled to the tooling head and configured to dispense a second type of gap filler material. A gap filler dispensing system is configured to supply the first and second types of gap filler material to the respective first and second dispensing nozzles to simultaneously apply the first and second types of gap filler to a component on the assembly line.

In addition to the foregoing, the described robotic gap filler application station may include one or more of the following features: wherein the tooling head includes a servo variable pitch device operably coupled to the first and second dispensing nozzles, and wherein the servo variable pitch device is configured individually adjust a location of each of the first and second dispensing nozzles, wherein the servo variable pitch device is configured to move each of the first and second dispensing nozzles in a horizontal direction and a vertical direction; a third dispensing nozzle configured to be removably coupled to the tooling head and dispense a third type of gap filler material; and wherein the tooling head includes a nozzle switching mechanism to releasably couple the first, second, and third dispensing nozzles to the tooling head, wherein the nozzle switching mechanism is configured to selectively and individually releasably uncouple each of the first, second, and third dispensing nozzles into an associated nozzle nest when the first, second, or third dispensing nozzle is not needed.

In addition to the foregoing, the described robotic gap filler application station may include one or more of the following features: wherein the nozzle switching mechanism is configured to removably couple and uncouple the associated dispensing nozzle from the tooling head when moving the associated dispensing nozzle between the dispensing position and non-dispensing position; wherein the gap filler dispensing system includes one or more reservoirs configured to store the first and second types of gap filler material, one or more supply lines fluidly coupling the one or more reservoirs to the first and second dispenser nozzles, and a metering system configured to control the flow of gap filler material through the one or more supply lines; wherein the metering system includes one or more pumps, one or more valves, and one or more pressure regulators; wherein the first and second types of gap filler material are different gap filler materials; and wherein the first and second types of gap filler material are the same gap filler material.

In accordance with another example aspect of the invention, a method is provided of operating a robotic gap filler application station having a robotic arm, a tooling head coupled to an end of the robotic arm, a first dispensing nozzle removably coupled to the tooling head and configured to dispense a first type of gap filler material, a second dispensing nozzle removably coupled to the tooling head and configured to dispense a second type of gap filler material, and a gap filler dispensing system configured to supply the first and second types of gap filler material to the respective first and second dispensing nozzles. In one example implementation, the method includes receiving, with a controller, dispensing settings and parameters for a product component on an assembly line, operating, with the controller, the robotic arm to move the first and second dispensing nozzles into specific locations proximate the product component, based on the received dispensing settings and parameters, and operating, with the controller, the gap filler dispensing system to simultaneously dispense the first and second types of gap filler material from the respective first and second dispensing nozzles and onto the product component in a predetermined shape and pattern based on the received dispensing settings and parameters.

In addition to the foregoing, the described method may include one or more of the following features: wherein the robotic gap filler application station further includes a servo variable pitch device operably coupled to the first and second dispensing nozzles, and the method further includes operating, with the controller, the servo variable pitch device to individually move each of the first and second dispensing nozzles into the specific locations proximate the product component, based on the received dispensing settings and parameters; and wherein the servo variable pitch device is configured to move each of the first and second dispensing nozzles in a horizontal direction and a vertical direction.

In addition to the foregoing, the described method may include one or more of the following features: wherein the robotic gap filler application station further includes a third dispensing nozzle configured to removably couple to the tooling head and dispense a third type of gap filler material; and wherein the robotic gap filler application station further includes a nozzle switching mechanism configured to releasably couple each of the first, second, and third dispensing nozzles to the tooling head.

In addition to the foregoing, the described method may include one or more of the following features: moving, via the controller, the first dispensing nozzle to a nozzle nest configured to hold the third dispensing nozzle, and actuating the nozzle switching mechanism, via the controller, to release the first dispensing nozzle into the nozzle nest; moving, via the controller, the tooling head to a location of the third dispensing nozzle in the nozzle nest, and actuating the nozzle switching mechanism, via the controller, to couple the third dispensing nozzle to the tooling head; and wherein the first and second types of gap filler material are simultaneously dispensed from the respective first and second dispensing nozzles onto an onboard charger for an electric vehicle.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example robotic gap filler application station in accordance with the principles of the present application;

FIG. 2 is an enlarged view of an example tooling head of the robotic gap filler application station shown in FIG. 1, in accordance with the principles of the present application; and

FIG. 3 illustrates an example method of operating the robotic gap filler application station shown in FIG. 1, in accordance with the principles of the present application.

### DETAILED DESCRIPTION

According to the principles of the present application, systems and methods are described for a robotic gap filler application station for an electric vehicle onboard charger assembly process. In one example, the robotic gap filler application station includes a robotic arm with a tooling head integrated with two or more gap filler dispensing machines, which can use the same type of gap filler material or different types of gap filler material. The tooling head includes a servo variable pitch device configured to automatically and individually adjust the relative locations of the individual gap filler dispensing machines, thereby allowing gap filler material to be applied in multiple different locations to improve production capacity. Because of the product characteristics of gap filler material (e.g., high viscosity) and quality concern, gap filler application is required to be slow. Accordingly, the plurality of individually adjustable gap filler dispensing machines enables improved production capacity at each robotic gap filler application station and potentially a reduced number of stations required by gap filler material variants.

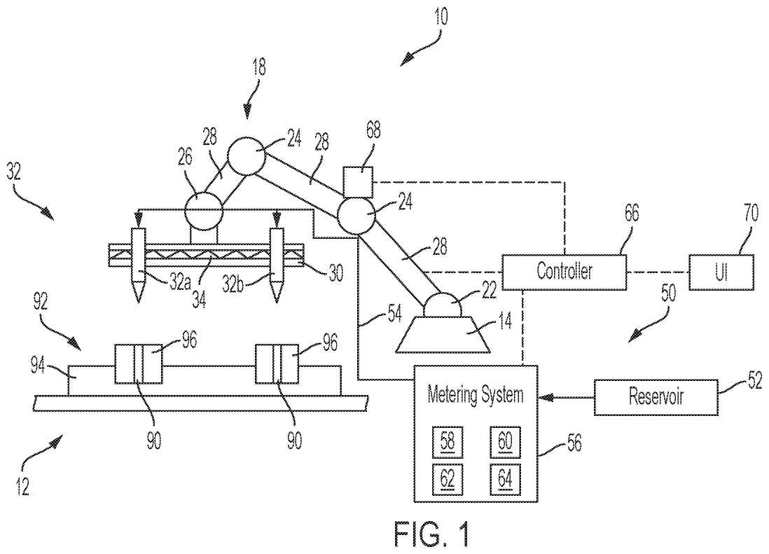

With initial reference to FIG. 1, robotic gap filler application station 10 is illustrated in accordance with the principles of the present disclosure. In the example embodiment, robotic gap filler application station 10 is an industrial sized machine configured for use on an assembly line 12. In the particular example, the robotic gap filler application station 10 is utilized to apply liquid gap filler material 90 to an assembly line product 92, such as an onboard charger for an electric vehicle. Due to its industrial size, the robotic gap filler application station 10 is configured to dispense large volumes of gap filler material in short cycle times to maximize production.

In the example illustration, the robotic gap filler application station 10 applies liquid gap filler material 90 to assembly line product 92 having a first component 94 and a second component 96 with a gap therebetween. The first component 94 may be a structural component or housing, and the second component 96 may be subsequently placed onto the liquid gap filler material, for example, via another robotic station (not shown). The second component 96 may be an interior electronic component such as, for example, a capacitor, transformer, inductor, semiconductor, etc. In the example embodiment, the assembly line product 92 is an onboard charger for an electric vehicle. However, it will be appreciated that robotic gap filler application station 10 may be utilized for other types of components.

The gap filler material 90 may be a thermally conductive gap filling liquid material configured to be applied to the various components of the onboard charger 92 to enhance thermal performance thereof. In some examples, the liquid gap filling material 90 is configured to couple heat generating components with one or more nearby heat sink devices and harden at room temperature. The gap filling material 90 includes a high density of thermally conductive fillers (e.g., aluminum oxide) to enable adequate heat transfer and dissipation. However, it will be appreciated that various other types of gap filler material may be utilized with robotic gap filler application station 10 such as, for example, a foam glue, a structural glue, a thermal paste, or the like.

In the example embodiment, the robotic gap filler application station 10 generally includes a base 14 and an articulatable robotic arm 16 having one or more movable/rotatable joints 18. In the illustrated example, the articulatable robotic arm joints 18 include a movable/rotatable shoulder 22, one or more movable/rotatable elbows 24, and a movable/rotatable wrist 26 connected by a plurality of arm portions 28. As noted, the shoulder 22, elbows 24, and wrist 26 are motorized movable/rotatable joints configured to provide robotic station 10 with various degrees of freedom. Attached to the wrist 26 is an end effector or tooling head 30 configured to removably secure a plurality of gap filler dispenser nozzles 32 thereto. While the example embodiment is illustrated with three gap filler dispenser nozzles 32a-c, it will be appreciated that tooling head 30 may hold any desired number of gap filler dispenser nozzles. In this way, multiple gap filler dispenser nozzles 32 may simultaneously dispense liquid gap filler material to reduce production time and increase production capacity.

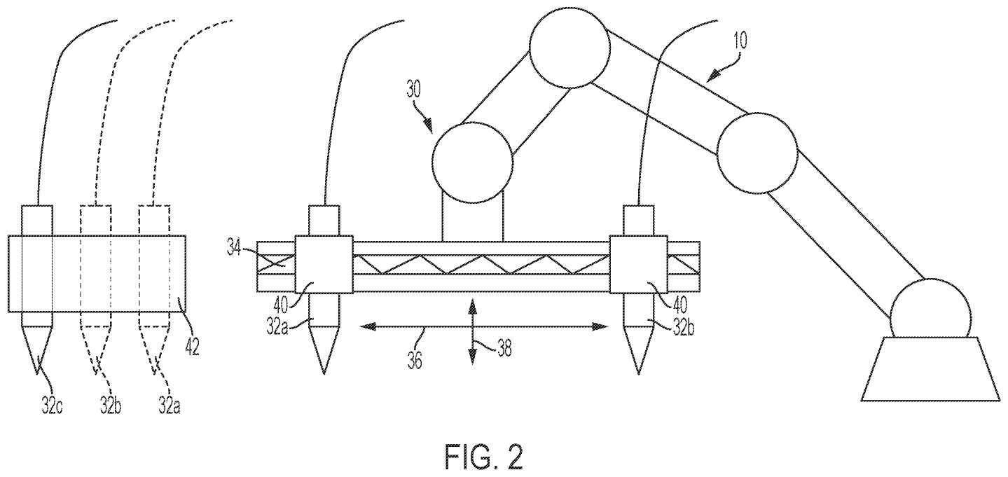

With additional reference to FIG. 2, the tooling head 30 includes a servo variable pitch device 34 configured to precisely adjust a position of each individual gap filler dispenser nozzle 32 on the tooling head 30. Each nozzle 32 is individually movable lengthwise (e.g., left/right as shown by arrows 36), as well as vertically (e.g., up/down as shown by arrows 38). In one example, each nozzle 32 is slidingly coupled to the tooling head 30 and servo variable pitch device 34 includes a servo motor and actuator (not shown) configured to slidingly move each nozzle 32 horizontally and vertically. Moreover, wrist 26 is configured to rotate/angle tooling head 30. In this way, the gap filler dispenser nozzles 32 are adjustable to various locations and orientations depending on the component being assembled.

In one example embodiment shown in FIG. 2, the tooling head 30 further includes one or more quick-change nozzle switching mechanisms 40 (two shown) configured to automatically switch to additional gap filler dispenser nozzles (e.g., 32c) stored in a nozzle holder or nest 42, which may be located on or proximate to the robotic gap filler application station 10. The nozzle switching mechanism 40 may include a gripping hand configured to releasably couple one dispenser nozzle 32 to the tooling head 30. In one example operation to switch dispenser nozzle 32a for dispenser nozzle 32c, the robotic arm 16 moves dispenser nozzle 32a to the nozzle nest 42. The nozzle switching mechanism 40 unclamps or uncouples dispenser nozzle 32a and releases dispenser nozzle 32a into the nozzle nest 42.

The robotic arm 16 then moves to the position of dispenser nozzle 32 in the nozzle nest 42, and nozzle switching mechanism 40 clamps or couples to dispenser nozzle 32c. The robotic arm 16 then picks up dispenser nozzle 32c and returns to the assembly line 12. Such an operation may be performed, for example, when the third dispenser nozzle 32c is configured to dispense a different type of liquid gap filler material than the first dispenser nozzle 32a. Or, in another example operation, the tooling head 30 may include a third switching mechanism 40 to provide a three-dispenser nozzle configuration. Additional dispenser nozzles (not shown) may be added or removed from the tooling head 30.

With continued reference to FIG. 1, robotic gap filler application station 10 further includes a gap filler dispensing system 50 that generally includes a reservoir 52, a supply line 54, a metering system 56, and the dispenser nozzles 32. The reservoir 52 is a storage tank or container configured to store the liquid gap filler material before dispensing, and the supply line 54 includes one or more conduits for supplying the liquid gap filler material from the reservoir 52 to the dispenser nozzles 32. The metering system 56 is configured to control the flow of gap filler material through the supply line 54 and the amount of gap filler material dispensed through nozzles 32. The metering system 56 regulates the flow of gap filler material via various components such as one or more pumps 58, one or more valves 60, one or more pressure regulators 62, one or more contaminant filters 64, or the like.

The pump 58 may be a positive displacement pump configured to precisely control the flow rate and volume of the gap filler material. As described herein, the dispensing nozzles 32 are configured to precisely dispense the metered liquid gap filler material onto target locations of a desired component in a precisely controlled pattern via movement of the robotic arm 16. Moreover, the nozzles 32 are fabricated from a material compatible with the liquid gap filler material, and have a shape that enables the nozzles to reach the surface locations where the gap filler material will be dispensed. The nozzles 32 are adjustable to control the size and shape of the dispensing pattern.

A controller 66 is in signal communication with the articulatable robotic arm 16, servo variable pitch device 34, nozzle switching mechanism 40, and gap filler dispensing system 50. In the example embodiment, the controller 66 includes programmable logic configured to read inputs from various sensors 68, and output controls to the articulatable robotic arm 16, the servo variable pitch device 34, the nozzle switching mechanism(s) 40, and the gap filler dispensing system 50. Controller 66 may also be in signal communication with a user interface 70 that enables an operator to adjust various settings and parameters of the robotic gap filler application station 10 such as, for example, gap filler material type, flow rate, dispensing location, and dispensing pattern for a given assembly line product 92.

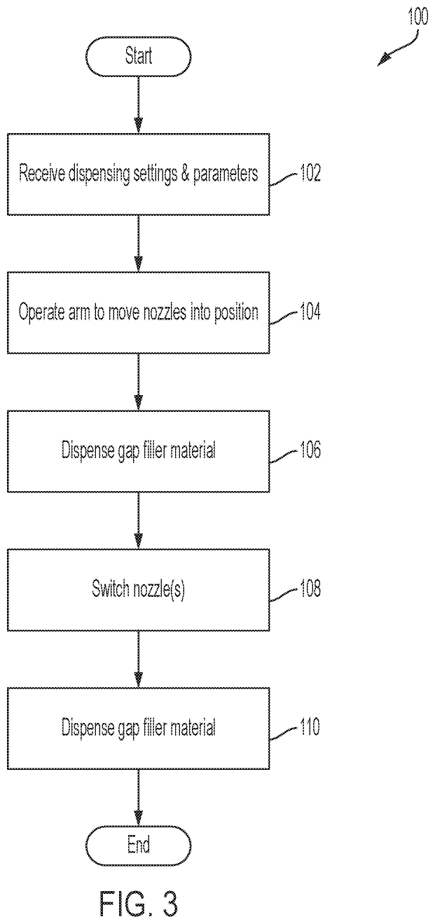

With reference now to FIG. 3, an example method 100 of operating the robotic gap filler application station 10 is provided. As described herein, the robotic gap filler application station 10 includes base 14, robotic arm 16, tooling head 30 with two or more nozzles 32, servo variable pitch device 34, nozzle switching mechanism 40, gap filler dispensing system 50, controller 66, sensors 68, and user interface 70. The method 100 begins at step 102 where controller 66 receives dispensing settings and parameters, for example, from operator input into user interface 70. The settings and parameters are specific to the desired gap filler application for the assembly line product 92 such as an EV onboard charger.

At step 104, the controller 66 operates the robotic arm 16 and servo variable pitch device 34 to move each of the multiple nozzles 32 into specific locations based on the received settings/parameters and signals from the sensors 68. At step 106, based on the received settings/parameters and signals from sensors 68, controller 66 operates the gap filler dispensing system 50 to dispense the liquid gap filler material 90 from the multiple nozzles 32.

In this way, the controller 66 simultaneously and precisely applies the gap filler material 90 to multiple locations on the onboard charger 92 in a desired shape/pattern. At step 108, controller 66 operates the nozzle switching mechanism 40 to add or remove additional dispensing nozzles 32 at the nozzle nest 42, based on the received settings/parameters. At step 110, controller 66 further operates the gap filler dispensing system 50 to dispense the liquid gap filler material 90 from the new group of multiple nozzles 32.

Described herein are systems and methods for a robotic gap filler application station for an electric vehicle onboard charger assembly process. The robotic station includes a robotic arm with a tooling head integrated with two or more selectively removable gap filler dispensing nozzles, which can use the same type of gap filler material or different types of gap filler material. A servo variable pitch device automatically and individually adjusts the relative locations of the individual gap filler dispensing nozzles, thereby allowing gap filler material to be applied in multiple different locations to improve production capacity. A nozzle switching mechanism enables the addition or removal of additional nozzles for dispensing, thereby increasing the adaptability of the robotic station to different types of components. As such, the robotic station advantageously performs tasks that previously required multiple robotic stations, thereby increasing production speed and capacity.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A robotic gap filler application station for an assembly line, comprising:
a robotic arm;
a tooling head coupled to an end of the robotic arm;
a first dispensing nozzle removably coupled to the tooling head and configured to dispense a first type of gap filler material;
a second dispensing nozzle removably coupled to the tooling head and configured to dispense a second type of gap filler material; and
a gap filler dispensing system configured to supply the first and second types of gap filler material to the respective first and second dispensing nozzles to simultaneously apply the first and second types of gap filler to a component on the assembly line.

2. The robotic gap filler application station of claim 1, wherein the tooling head includes a servo variable pitch device operably coupled to the first and second dispensing nozzles, and
wherein the servo variable pitch device is configured individually adjust a location of each of the first and second dispensing nozzles.

3. The robotic gap filler application station of claim 2, wherein the servo variable pitch device is configured to move each of the first and second dispensing nozzles in a horizontal direction and a vertical direction.

4. The robotic gap filler application station of claim 1, further comprising a third dispensing nozzle configured to be removably coupled to the tooling head and dispense a third type of gap filler material.

5. The robotic gap filler application station of claim 4, wherein the tooling head includes a nozzle switching mechanism to releasably couple the first, second, and third dispensing nozzles to the tooling head,
wherein the nozzle switching mechanism is configured to selectively and individually releasably uncouple each of the first, second, and third dispensing nozzles into an associated nozzle nest when the first, second, or third dispensing nozzle is not needed.

6. The robotic gap filler application station of claim 1, wherein the gap filler dispensing system comprises:
one or more reservoirs configured to store the first and second types of gap filler material;
one or more supply lines fluidly coupling the one or more reservoirs to the first and second dispenser nozzles; and
a metering system configured to control the flow of gap filler material through the one or more supply lines.

7. The robotic gap filler application station of claim 6, wherein the metering system comprises:
one or more pumps;
one or more valves; and
one or more pressure regulators.

8. The robotic gap filler application station of claim 1, wherein the first and second types of gap filler material are different gap filler materials.

9. The robotic gap filler application station of claim 1, wherein the first and second types of gap filler material are the same gap filler material.

10. A method of operating a robotic gap filler application station having a robotic arm, a tooling head coupled to an end of the robotic arm, a first dispensing nozzle removably coupled to the tooling head and configured to dispense a first type of gap filler material, a second dispensing nozzle removably coupled to the tooling head and configured to dispense a second type of gap filler material, and a gap filler dispensing system configured to supply the first and second types of gap filler material to the respective first and second dispensing nozzles, the method comprising:
receiving, with a controller, dispensing settings and parameters for a product component on an assembly line;
operating, with the controller, the robotic arm to move the first and second dispensing nozzles into specific locations proximate the product component, based on the received dispensing settings and parameters; and
operating, with the controller, the gap filler dispensing system to simultaneously dispense the first and second types of gap filler material from the respective first and second dispensing nozzles and onto the product component in a predetermined shape and pattern based on the received dispensing settings and parameters.

11. The method of claim 10, wherein the robotic gap filler application station further includes a servo variable pitch device operably coupled to the first and second dispensing nozzles, the method further comprising:
operating, with the controller, the servo variable pitch device to individually move each of the first and second dispensing nozzles into the specific locations proximate the product component, based on the received dispensing settings and parameters.

12. The method of claim 11, wherein the servo variable pitch device is configured to move each of the first and second dispensing nozzles in a horizontal direction and a vertical direction.

13. The method of claim 11, wherein the robotic gap filler application station further includes a third dispensing nozzle configured to removably couple to the tooling head and dispense a third type of gap filler material.

14. The method of claim 13, wherein the robotic gap filler application station further includes a nozzle switching mechanism configured to releasably couple each of the first, second, and third dispensing nozzles to the tooling head.

15. The method of claim 14, further comprising:
moving, via the controller, the first dispensing nozzle to a nozzle nest configured to hold the third dispensing nozzle; and
actuating the nozzle switching mechanism, via the controller, to release the first dispensing nozzle into the nozzle nest.

16. The method of claim 15, further comprising:
moving, via the controller, the tooling head to a location of the third dispensing nozzle in the nozzle nest; and
actuating the nozzle switching mechanism, via the controller, to couple the third dispensing nozzle to the tooling head.

17. The method of claim 10, wherein the first and second types of gap filler material are simultaneously dispensed from the respective first and second dispensing nozzles onto an onboard charger for an electric vehicle.
